(19) United States
(12) Patent Application Publication
(10) Pub. No.: US 2025/0390353 A1
(43) Pub. Date: Dec. 25, 2025

(54) Scheduling Method of Processing Unit

(71) Applicant: MEDIATEK INC., Hsin-Chu (TW)

(72) Inventors: Chun-Yu Wang, Hsinchu City (TW); Tso-Jui Lin, Hsinchu City (TW); Ping-Yi Hsu, Hsinchu City (TW)

(73) Assignee: MEDIATEK INC., Hsin-Chu (TW)

(21) Appl. No.: 18/747,464

(22) Filed: Jun. 19, 2024

(51) Int. Cl. G06F 9/50; G06F 9/48

(52) U.S. Cl. CPC G06F 9/5033; G06F 9/4881

(57) ABSTRACT

A scheduling method of a processing unit (PU) includes a plurality of cores. The method includes assigning an affinity code for each one of a plurality of tasks and allocating at least one core of the plurality of cores to at least one task of the plurality of tasks according to a plurality of affinity codes assigned to the plurality of tasks after the plurality of tasks are in a scheduling queue. Each affinity code includes a plurality of bits; each bit of the plurality of bits indicates whether a task is allowed to be executed on a corresponding core of the plurality of cores.

### BACKGROUND

Scheduling of processes or tasks is to complete tasks in an efficient way. Scheduling is a process that allows one process or task to use the processing unit while another process or task is delayed or in standby due to unavailability of any resources, thus making full use of the processing unit. The purpose of scheduling is to make the system more efficient, faster, and fairer.

However, some tasks may have better results when executed on a specific hardware cores. If the tasks are scheduled by using the first-come-first-served approach, the tasks may not be able to use the hardware that is more effective for the task, resulting in poor efficiency or power consumption. The prior art ensured that tasks may be executed on specific hardware by adding dummy execution. However, adding dummy execution may cause a waste of hardware computing power.

### SUMMARY

According to an embodiment of the invention, a scheduling method of a processing unit (PU) includes a plurality of cores. The method includes assigning an affinity code for each one of a plurality of tasks and allocating at least one core of the plurality of cores to at least one task of the plurality of tasks according to a plurality of affinity codes assigned to the plurality of tasks after the plurality of tasks are in a scheduling queue. Each affinity code includes a plurality of bits; each bit of the plurality of bits indicates whether a task is allowed to be executed on a corresponding core of the plurality of cores.

According to another embodiment of the invention, a scheduling method of an AI (artificial intelligence) processing unit (APU) includes a first group of cores. The method includes assigning affinity codes for a first group of tasks and a second group of tasks to make each task in the first group of tasks have a same affinity code with the task at a same position in the second group of tasks, allocating the first group of cores to the first group of tasks at a first period of time after the first group of tasks are in the scheduling queue; and allocating the first group of cores to the second group of tasks at a second period of time after the second group of tasks are in the scheduling queue. The first period of time and the second period of time do not overlap.

According to another embodiment of the invention, a non-transitory machine-readable medium is configured to store a program code. When loaded and executed by a processor including a plurality of cores, the program code instructs the processor to execute: assigning an affinity code for each one of a plurality of tasks, and allocating at least one core of the plurality of cores to at least one task of the plurality of tasks according to a plurality of affinity codes assigned to the plurality of tasks after the plurality of tasks are in a scheduling queue. Each affinity code includes a plurality of bits; each bit of the plurality of bits indicates whether a task is allowed to be executed on a corresponding core of a plurality of cores.

According to another embodiment of the invention, a non-transitory machine-readable medium is configured to store a program code. When loaded and executed by a processor including a first group of cores, the program code instructs the processor to execute: assigning affinity codes for a first group of tasks and a second group of tasks to make each task in the first group of tasks have a same affinity code with the task at a same position in the second group of tasks, allocating the first group of cores to the first group of tasks at a first period of time after the first group of tasks are in the scheduling queue; and allocating the first group of cores to the second group of tasks at a second period of time after the second group of tasks are in the scheduling queue. The first period of time and the second period of time do not overlap.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a flowchart of a processing unit scheduling method according to an embodiment of the present invention.

FIG. 2 shows a schematic diagram of an affinity code according to an embodiment of the present invention.

FIG. 3 shows a flowchart of Step S200 of the processing unit scheduling method in FIG. 1.

FIGS. 4 to 9 show schematic diagrams of Step S200 according to an embodiment of the present invention.

FIG. 10 shows a schematic diagram of assigning affinity codes according to another embodiment of the present invention.

FIG. 11 shows a computer system for performing a processing unit scheduling method.

### DETAILED DESCRIPTION

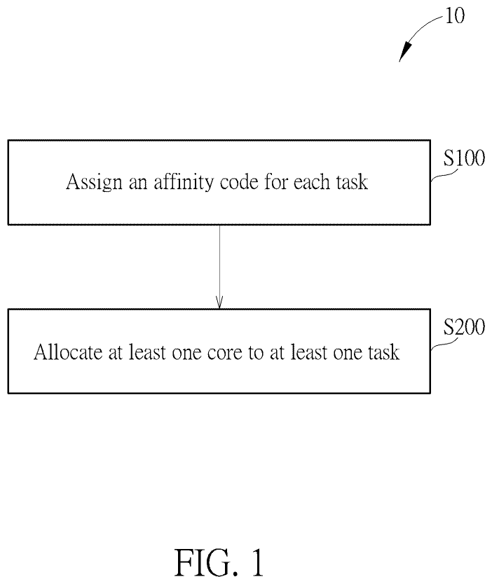

FIG. 1 shows a flowchart of a processing unit (PU) scheduling method 10 according to an embodiment of the present invention. The PU may be an AI (artificial intelligence) processing unit (APU). The PU scheduling method 10 includes Steps S100 to S200. Any reasonable step change or adjustment is within the scope of the disclosure. Steps S100 to S200 are explained as follows:

Step S100: Assign an affinity code for each task;

Step S200: Allocate at least one core to at least one task.

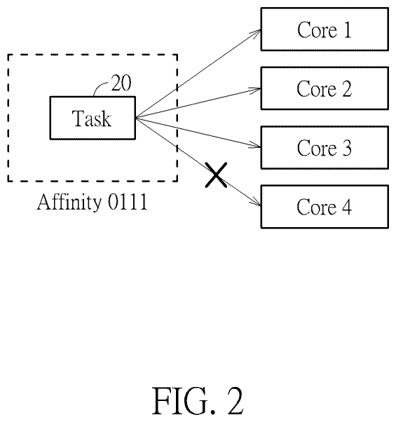

In Step S100, an affinity code for each task which will be executed on at least one core of a plurality of cores of the PU is assigned. Each core is a hardware core, and a hardware core may be a processing unit, a random access memory (RAM), or a storage device such as a hard drive or a solid-state drive (SSD), but not limited thereto. Each affinity code includes a plurality of bits, and each of the plurality of bits indicates whether the task is allowed to be executed on a corresponding core of the plurality of cores. Please refer to FIG. 2 for an example of an affinity code. FIG. 2 shows a schematic diagram of an affinity code of a task 20 according to an embodiment of the present invention. As shown in FIG. 2, the affinity code of the task 20 includes 4 bits, which is 0111. Each bit indicates whether the task 20 is allowed to be executed on a corresponding core. A bit value of 1 permits the execution of task 20 on the corresponding core, while a bit value of 0 prohibits it. For example, the first bit (the least significant bit) of the task 20 is 1, permitting the task 20 to be executed on the first core; the second bit of the task 20 is 1, permitting the task 20 to be executed on the second core; the third bit of the task 20 is 1, permitting the task 20 to be executed on the third core; and the fourth bit of the task 20 is 0, prohibiting the task 20 to be executed on the fourth core.

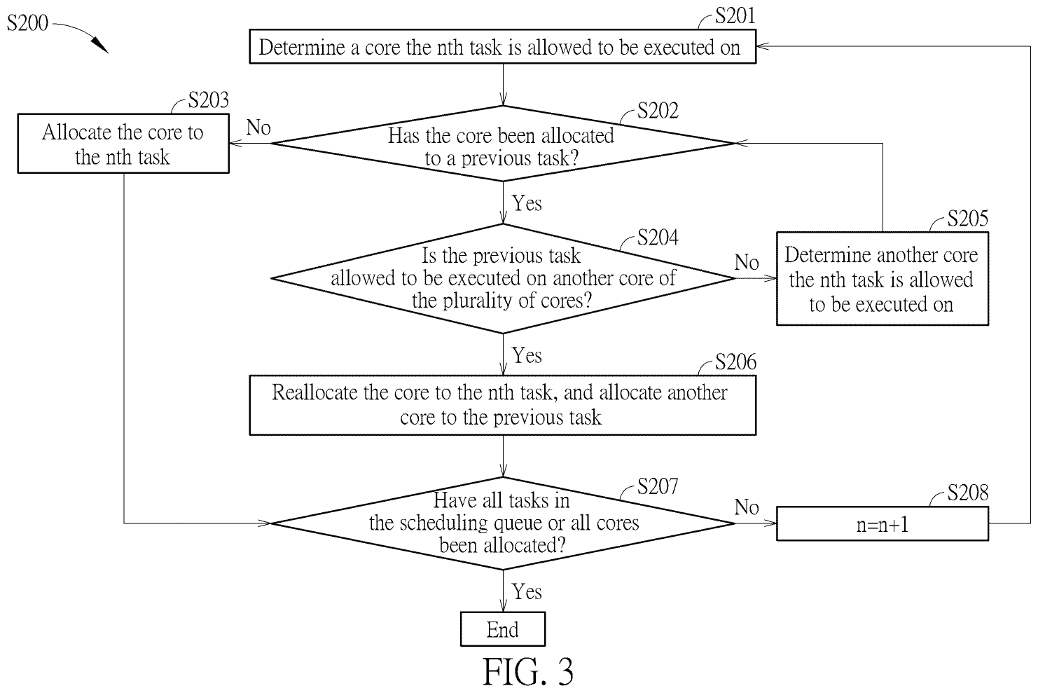

In Step S200, at least one core of the plurality of cores is allocated to at least one task of a plurality of tasks according to affinity codes of the plurality of tasks after the plurality of tasks are in a scheduling queue. The scheduling queue is a sequence of tasks awaiting their turn to be allocated and executed. The allocation may follow an algorithm, and the algorithm may be a bipartite matching algorithm, but not limited thereto. A bipartite matching is a set of the edges chosen in such a way that no two edges share an endpoint, and may be used to solve allocation or grouping problems. FIG. 3 shows a flowchart of Step S200 of the processing unit scheduling method 10 in FIG. 1. Step S200 includes Steps S201 to S208. Any reasonable step change or adjustment is within the scope of the disclosure. Steps S201 to S208 are explained as follows:

Step S201: Determine a core the nth task is allowed to be executed on;

Step S202: Has the core been allocated to a previous task? If so, go to Step S204; else go to Step S203;

Step S203: Allocate the core to the nth task; go to Step

S207;

Step S204: Is the previous task allowed to be executed on another core of the plurality of cores? If so, go to Step S206; else go to Step S205;

Step S205: Determine another core the nth task is allowed to be executed on; go to Step S202;

Step S206: Reallocate the core to the nth task, and allocate another core to the previous task;

Step S207: Have all tasks in the scheduling queue or all cores been allocated? If so, end; else go to Step S208; Step S208: n=n+1; go to Step S201.

In Step S201, traverse the bits of the affinity code of the nth task of the plurality of tasks to determine a core the nth task is allowed to be executed on. Starting from n=1, and traverse from the first bit (the least significant bit) of the affinity code of the nth task to determine a core the nth task is allowed to be executed on. Once there is a bit of the affinity code of the nth task indicates the nth task is allowed to be executed on a corresponding core, stop traversing and perform Step S202. A recording table is created to record the allocation status of the plurality of cores when traversing the bits of the affinity code of the nth task has started. In some embodiments, when n>1, the recording table may be reset instead of created to record the allocation status of the plurality of cores as it begins to traverse the bits of the affinity code for the nth task.

Then, in Step S202, check whether the core determined in Step S201 has been allocated to a previous task. The previous task is the kth task of the plurality of tasks, where k<n. If the core has been allocated to a previous task, then perform Step S204. If the core hasn't been allocated to a previous task, perform Step S203. The way to check whether the core has been allocated to a previous task is to check a core table. The core table is a table which records the occupancy of each core. If the core has been allocated to a previous task according to one of the bits of the affinity code of the previous task, it is recorded in the core table that the core has been allocated to the previous task. Therefore, by checking the core table, whether the core has been allocated to a previous task may be determined. The difference between the core table and the recording table is that the core table records the occupancy of each core of the plurality of cores of the tasks and the recording table records the allocation status of the plurality of cores when allocating the nth task. The allocation status may be whether the cores have been visited during the allocation of the nth task.

In Step S202, if the core hasn't been allocated to a previous task, allocate the core to the nth task in Step S203. If the core has been allocated to a previous task, check whether the previous task is allowed to be executed on another core of the plurality of cores by traversing the bits of the affinity code of the previous task from the next bit of the bit of the affinity code of the previous task corresponding to the core in Step S204. Once another bit of the affinity code of the previous task indicates the previous task is allowed to be executed on another core, stop traversing and perform Step S206. If the previous task is prohibited to be executed on another core, perform Step S205.

In Step S204, if the previous task is prohibited to be executed on another core, the core is retained to the previous task and Step S205 is performed to move to the next bit of the bit corresponding to the core. Then the bits of the affinity code of the nth task are traversed from the next bit to determine an alternative core the nth task is allowed to be executed on. Once another bit of the affinity code of the nth task indicates the nth task is permitted to be executed on an alternative core, traversing is stopped and Step S202 is performed. If the affinity code for the nth task does not have any other bit indicating permission to be executed on an alternative core, then the nth task wait will remain in the scheduling queue awaiting allocation.

In Step S204, if the previous task is allowed to be executed on another core, then in Step S206, the core is reallocated to the nth task, and another core is allocated to the previous task.

After allocating the core in Step S203 or Step S206, Step S207 is performed to determine if all tasks in the scheduling queue or all cores of the plurality of cores have been allocated. In some embodiments, if all tasks in the scheduling queue have been allocated corresponding cores of the plurality of cores or all cores of the plurality of cores have been allocated, Step S200 is completed. Otherwise Step S208 is performed to increment n, indicating moving to the next task to perform Step S201 for the next task. In some embodiments, if all cores are allocated and some tasks remain unassigned in the scheduling queue, the tasks will proceed to Step S201 to be assigned cores once they become available. Step S200 concludes once every task in the scheduling queue has been assigned a core.

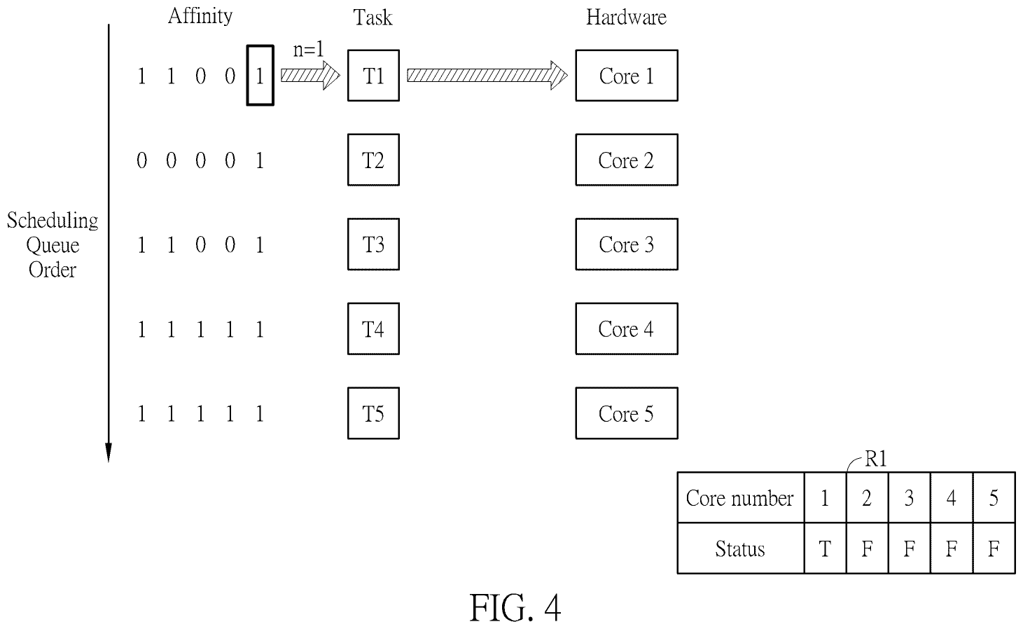

Please refer to FIGS. 4 to 9 for an example of Step S200. FIGS. 4 to 9 show schematic diagrams of Step S200 according to an embodiment of the present invention. As shown in FIG. 4, begin with the first bit (the least significant bit) of the affinity code for the first task T1 (n=1) and proceed through the bits to identify a suitable core for executing the first task T1. When a bit of the affinity code of the first task T1 indicates the first task T1 is allowed to be executed on a core of the plurality of cores, since there is no previous task, the core is allocated to the first task T1. As shown in FIGS. 4 to 9, each affinity code includes 5 bits, and each bit indicates whether the corresponding task is allowed to be executed on a corresponding core. The first bit to the fifth bit correspond to Core 1 to Core 5 respectively. Since the first bit of the affinity code of the first task T1 is 1, indicating the first task T1 is allowed to be executed on Core 1, Core 1 is allocated to the first task T1. A recording table R1 is created to record the allocation status of the plurality of cores when starts traversing the bits of the affinity code of the first task T1. The upper row of a recording table indicates the core number, and the lower row indicates if the core has been occupied. Since Core 1 has been visited, the status of core number 1 is T (True).

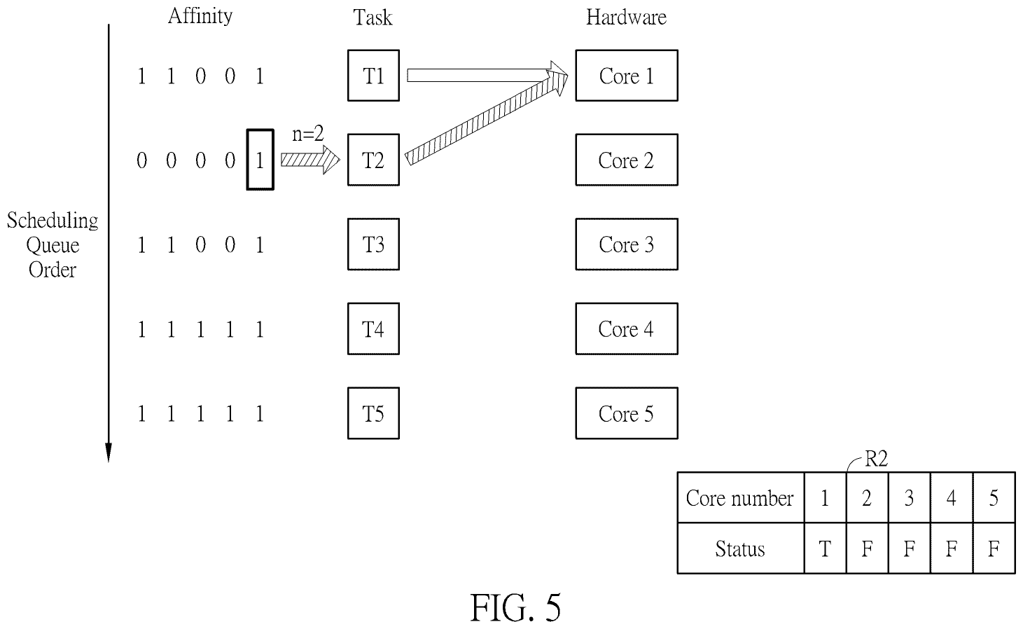

As shown in FIG. 5, begin with the first bit of the affinity code of the second task T2 (n=2) to determine a core the second task T2 is allowed to be executed on. Since the first bit of the affinity code of the second task T2 is 1, indicating the second task T2 is allowed to be executed on Core 1, and then check whether Core 1 has been allocated to a previous task. A recording table R2 is created to record the allocation status of the plurality of cores when starts traversing the bits of the affinity code of the second task T2. In some embodiment, instead of creating the recording table R2, the recording table R1 is reset and used as the recording table R2. As shown in FIG. 5, Core 1 has been visited, so the status of core number 1 in the recording table R2 is T (True).

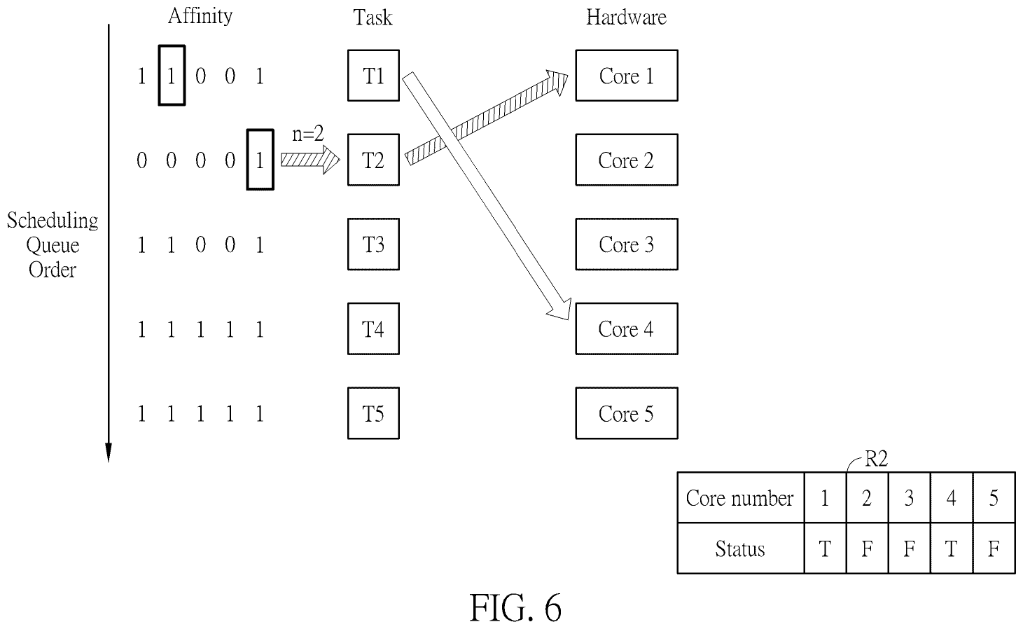

Since Core 1 has been allocated to the first task T1, check whether the first task T1 is allowed to be executed on another core by traversing the bits of the affinity code of the first task T1 from the next bit (the second least significant bit) of the bit of (the least significant bit) the affinity code of the first task T1 corresponding to Core 1. As shown in FIG. 6, by traversing from the second bit of the affinity code of the first task T1, it may be found that the value of the fourth bit is 1, indicating the first task T1 is allowed to be executed on Core 4. Since the first task T1 is allowed to be executed on Core 4, reallocate Core 1 to the second task T2, and allocate Core 4 to the first task T1. As shown in FIG. 6, Core 4 has been visited, so the status of core number 4 in the recording table R2 is T (True).

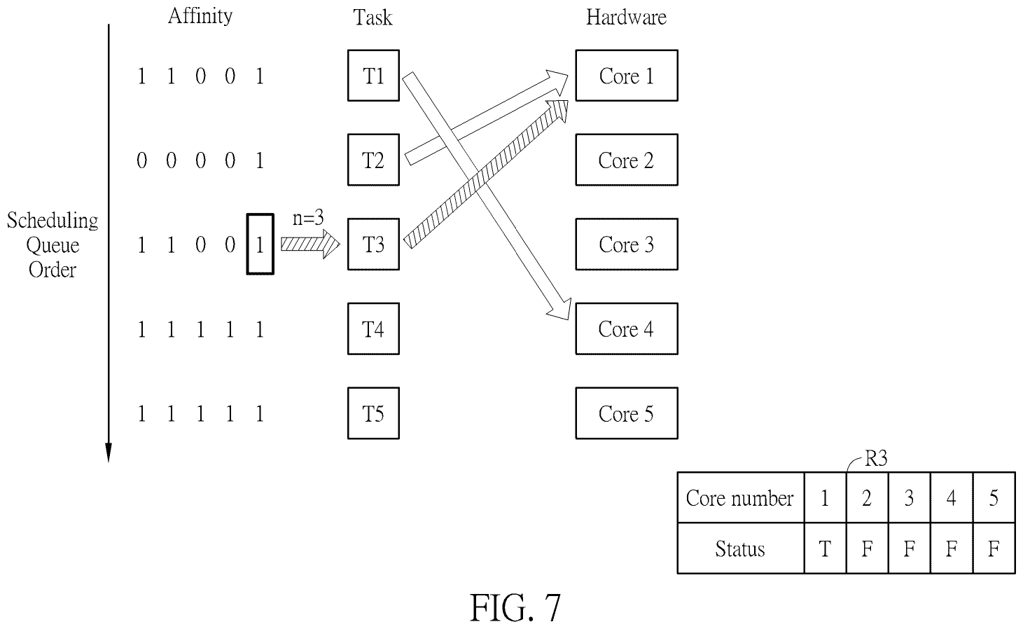

Then, as shown in FIG. 7, traverse from the first bit of the affinity code of the third task T3 (n=3) to determine a core the third task T3 is allowed to be executed on. Since the first bit of the affinity code of the third task T3 is 1, indicating the third task T3 is allowed to be executed on Core 1, and then check whether Core 1 has been allocated to a previous task. A recording table R3 is created to record the allocation status of the plurality of cores when starts traversing the bits of the affinity code of the third task T3. In some embodiment, instead of creating the recording table R3, the recording table R2 is reset and used as the recording table R3. As shown in FIG. 7, Core 1 has been visited, so the status of core number 1 in the recording table R3 is T (True).

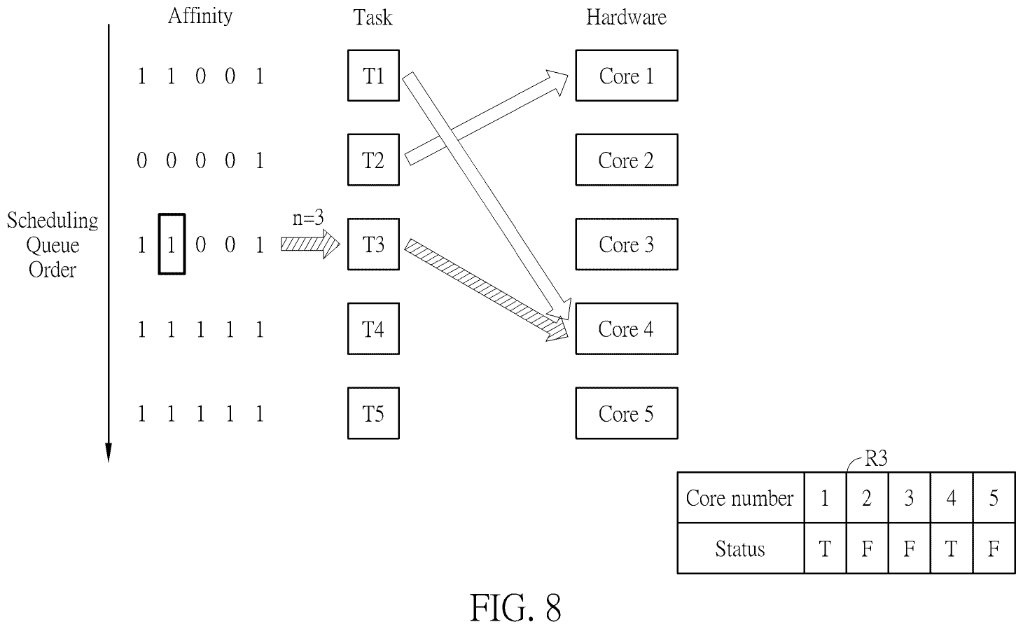

Since Core 1 has been allocated to the second task T2, check whether the second task T2 is allowed to be executed on another core by traversing the bits of the affinity code of the second task T2 from the next bit (the second least significant bit) of the bit of the affinity code of the second task T2 corresponding to Core 1. As shown in FIG. 8, since after the traversal, another core that allows the second task T2 to execute on may not be found, remain Core 1 allocated to the second task T2 and move to the next bit (the second bit) of the bit of the affinity code of the third task T3 corresponding to Core 1. Then traverse the bits of the affinity code of the third task T3 from the second bit to determine another core the third task T3 is allowed to be executed on. By traversing from the second bit of the affinity code of the third task T3, it may be found that the value of the fourth bit is 1, indicating the third task T3 is allowed to be executed on Core 4, and then check whether Core 4 has been allocated to a previous task. Since Core 4 has been visited, so the status of core number 4 in the recording table R3 is T (True).

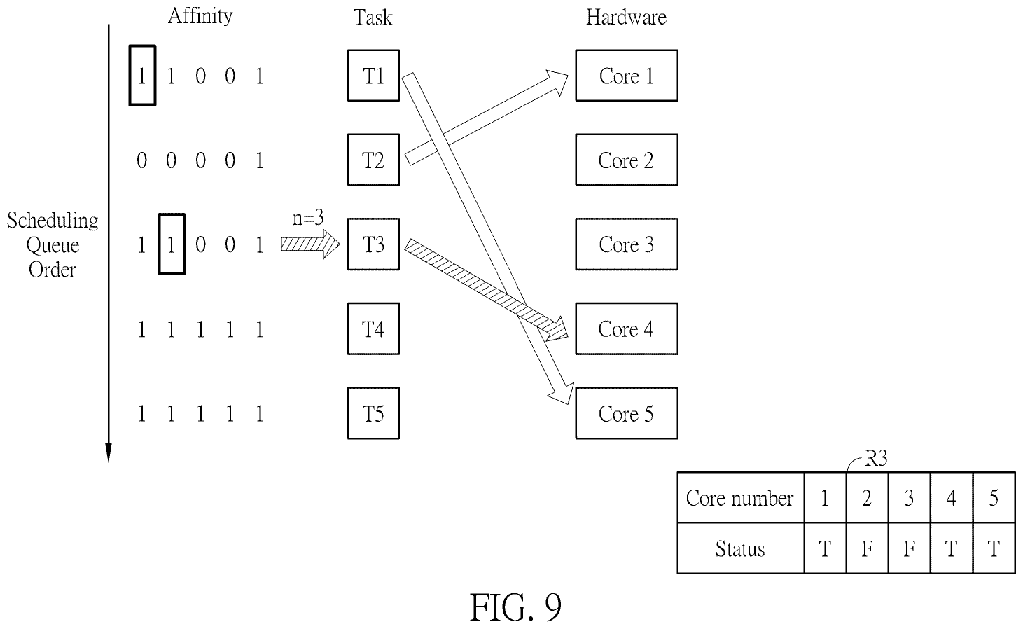

Since Core 4 has been allocated to the first task T1, check whether the first task T1 is allowed to be executed on another core by traversing the bits of the affinity code of the first task T1 from the next bit (the fifth least significant bit) of the bit of the affinity code of the first task T1 corresponding to Core 4. As shown in FIG. 9, by traversing from the fifth bit of the affinity code of the first task T1, it may be found that the value of the fifth bit is 1, indicating the first task T1 is allowed to be executed on Core 5. Since the first task T1 is allowed to be executed on Core 5, reallocate Core 4 to the third task T3, and allocate Core 5 to the first task T1. As shown in FIG. 9, Core 5 has been visited, so the status of core number 5 in the recording table R3 is T (True). The allocation when n=4 and n=5 is the same as above and will not be repeated here. The above examples are for illustration only and are not limited thereto. The affinity code and the corresponding core may be determined according to actual needs. By using the PU scheduling method 10 to allocate the cores to the task, the tasks may be executed on the core that is more effective for the task, making the execution more efficient and reducing power consumption.

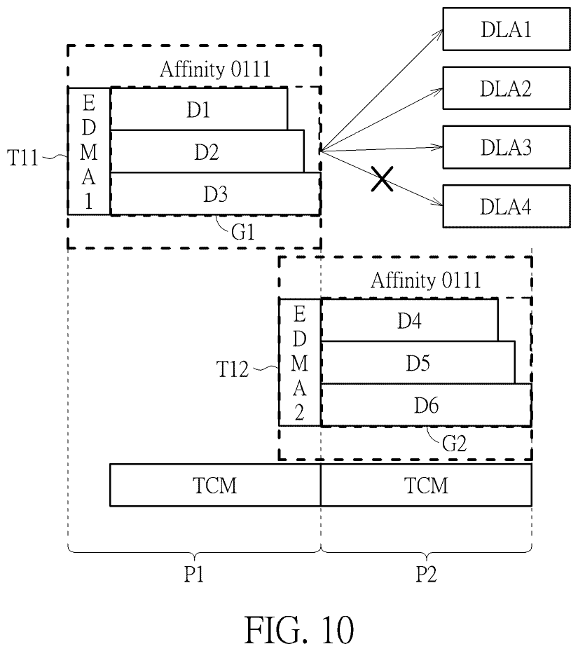

FIG. 10 shows a schematic diagram of assigning affinity codes according to another embodiment of the present invention. In some embodiments, the PU may be an APU, and a task may include multiple tasks. The multiple tasks included in the task may be called subtasks. In some AI applications, the same multiple tasks may be enabled and executed through pipeline. Each task may include a subtask to be executed on an enhanced direct memory access (EDMA) and three subtasks to be executed on deep learning accelerator (DLAs). An APU includes a fixed number of DLA and EDMA hardware, and may execute multiple tasks at the same time.

Please refer to FIG. 10 for an example, as shown in FIG. 10, there are two tasks T11 and T12 in sequence in a scheduling queue. The task T11 may include a subtask EDMA1 to be executed on an EDMA and three subtasks D1, D2 and D3 to be executed on DLAs. The task T12 may include a subtask EDMA2 to be executed on an EDMA and three subtasks D4, D5 and D6 to be executed on DLAs. The hardware core of an APU may include two EDMAs and four DLAs. Subtasks D1, D2 and D3 may form a group G1 of subtasks, and subtasks D4, D5 and D6 may form a group G2 of subtasks. In Step S100 of the PU scheduling method 10, assigning affinity codes for the subtasks in the groups G1 and G2 to make each subtask in the group G1 of subtasks have the same affinity code with the subtask at a same position in the group G2 of subtasks. That is, assign affinity codes so that subtasks D1 and D4 have the same affinity code, subtasks D2 and D5 have the same affinity code, and subtasks D3 and D6 have the same affinity code. As shown in FIG. 10, every subtask has the affinity code 0111, indicating the subtasks are allowed to be executed on the DLA DLA1, DLA2 and DLA3, and are not allowed to be executed on the DLA DLA4.

After assigning the affinity codes, in Step S200 in the PU scheduling method 10, a group of cores (the DLAs DLA1, DLA2 and DLA3) are allocated to the subtask in the group G1 in the first period of time P1. Then execute the group G1 of subtasks after the Step S200. When all subtasks in a group are allocated to hardware, the task will start executing. In other words, the task T11 may first be allocated one EDMA and three DLAs DLA1, DLA2 and DLA3 according to the affinity code and then start execution. Since there is only one EDMA and one DLA left in the APU at this time that have not been allocated, the number of DLAs may not sufficient to be allocated to each subtask in the group G2, the task T12 needs to wait for execution in the scheduling queue. In the prior art where the affinity code is not applied, when D1 and D2 are completed, the two DLAs are released, the number of DLAs(=3) may be sufficient to be allocated to each subtask in the group G2, and the subtasks D4, D5 and D6 may start executing while the subtask D3 is still executing. Since the execution of the subtasks D1, D2 and D3 occupies the whole space of a tightly coupled memory (TCM), if the subtasks D4, D5 and D6 execute before the release of TCM, subtasks D4, D5 and D6 may not use the TCM and may only use other more power consuming memories, such as dynamic random-access memory (DRAM), causing power consumption.

In the present invention, since affinity codes are applied and the affinity codes of the subtasks in the group G1 and the group G2 are the same, subtasks in the group G2 may not be executed until all subtasks in the group G1 are completed. After all subtasks in the group G1 are completed, repeat Step S200 at a second period of time P2 after the group G2 of tasks are in the scheduling queue to allocate the group of cores (the DLAs DLA1, DLA2 and DLA3) to the group G2 of tasks. Then execute the group G2 of subtasks after the Step S200. By using the affinity codes, both the execution of the group G1 of subtasks and the group G2 of subtasks may occupy the whole space of the TCM when executing without adding a dummy execution. The TCM saves power and executes faster than DRAM, thus reduce power consumption. The embodiment uses TCM as an example, but it is not limited thereto, in other embodiments, the execution of the subtasks may occupy other kinds of memory. And the example in FIG. 10 is for explanation, the number of subtasks and hardware configurations are not limited thereto. In addition, the first period of time p1 and the second period of time p2 do not overlap.

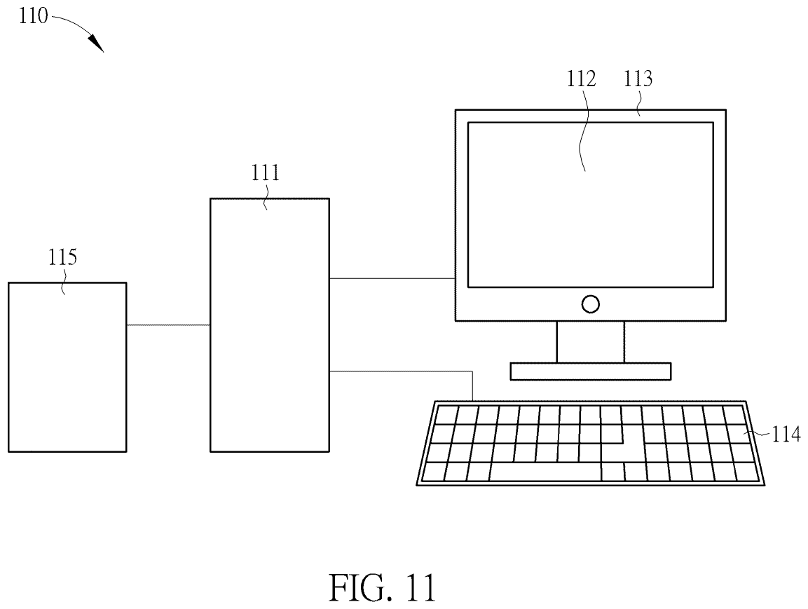

FIG. 11 shows a computer system 110 for performing a processing unit scheduling method. The computer system 110 includes a processor 111, a display device 113, an input device 114, and a non-transitory machine-readable medium 115. The processor 111 may be a central processing unit (CPU). The display device 113, the input device 114 and the non-transitory machine-readable medium 115 are connected to the processor 111. The non-transitory machine-readable medium 115 may store machine-executable instructions and program code thereon, that when loaded and executed by the processor 111, cause the processor 111 to perform the methods of this disclosure (such as, the methods mentioned with FIGS. 1, 3 and 10), and the result may be displayed on a graphical user interface (GUI) 112 on the display device 113. Users may interact with the graphical user interface 112 and interact with the result using the input device 114. The input device 114 may be a mouse, a touch pad or a keyboard.

By using the methods of this disclosure to allocate the cores to the tasks, the tasks may be executed on the cores more effectively. And in some embodiments, by using the affinity codes, the execution of a group of tasks and another group of tasks may each occupy the whole space of a specific memory, such as a TCM. The TCM saves power and executes faster than DRAM, reducing power consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A scheduling method of a processing unit (PU) comprising a plurality of cores, the method comprising:
assigning an affinity code for each one of a plurality of tasks, wherein each affinity code comprises a plurality of bits, each bit of the plurality of bits indicates whether a task is allowed to be executed on a corresponding core of the plurality of cores; and
allocating at least one core of the plurality of cores to at least one task of the plurality of tasks according to a plurality of affinity codes assigned to the plurality of tasks after the plurality of tasks are in a scheduling queue.

2. The method of claim 1, wherein allocating at least one core of the plurality of cores to at least one task of the plurality of tasks according to the plurality of affinity codes assigned to the plurality of tasks comprises:
allocating a corresponding core of the plurality of cores to a first task of the plurality of tasks when a bit of the affinity code of the first task indicates the first task is allowed to be executed on the corresponding core of the plurality of cores.

3. The method of claim 2, wherein allocating at least one core of the plurality of cores to at least one task of the plurality of tasks according to the plurality of affinity codes assigned to the plurality of tasks further comprises:
for a second task beyond the first task, traverse the bits of the affinity code of the second task, whenever there is a bit of the affinity code of the second task indicates the second task is allowed to be executed on a corresponding core of the plurality of cores, executing the following steps:
checking whether the corresponding core has been allocated to a previous task according to one of the bits of the affinity code of the previous task or a core table of the corresponding core;
if the corresponding core has been allocated to a previous task, checking whether the previous task is allowed to be executed on another core of the plurality of cores according to one of the bits of the affinity code of the previous task;
reallocating the corresponding core to the second task, and allocating another core to the previous task when the previous task is allowed to be executed on another core, while remaining allocating the corresponding core to the previous task and moving to a next bit of the affinity code of the second task when the previous task isn't allowed to be executed on another core; and
if the corresponding core hasn't been allocated to a previous task, allocating the corresponding core to the second task.

4. The method of claim 3, further comprising:
creating or resetting a recording table to record the allocation status of the plurality of cores when starts traversing the bits of the affinity code of the second task.

5. The method of claim 3, wherein ending if all tasks of the plurality of tasks in the scheduling queue have been allocated a corresponding core of the plurality of cores.

6. The method of claim 3, wherein ending if all cores of the plurality of cores have been allocated.

7. The method of claim 1, wherein the allocating step is executed at a first period of time, and a first group of cores of the plurality of cores are allocated to a first group of tasks of the plurality of tasks at the end of the allocating step;
wherein the assigning step further comprises:
assigning affinity codes for the first group of tasks and a second group of tasks of the plurality of tasks to make each task in the first group of tasks have a same affinity code with the task at a same position in the second group of tasks.

8. The method of claim 7, further comprising:
repeating the allocating step at a second period of time after the second group of tasks are in the scheduling queue to allocate the first group of cores to the second group of tasks, wherein the first period of time and the second period of time do not overlap.

9. The method of claim 7, wherein the PU is an AI processing unit (APU), the first and second groups of tasks comprise subtasks to be executed of deep learning accelerator (DLA).

10. The method of claim 9, further comprising:
executing the first group of tasks after the allocating step, wherein the execution of the first group of tasks occupying the whole space of a tightly coupled memory (TCM); and
executing the second group of tasks after repeating the allocating step, wherein the execution of the second group of tasks occupying the whole space of the TCM.

11. A scheduling method of an AI (artificial intelligence) processing unit (APU), wherein the APU comprises a first group of cores, and the method comprising:
assigning affinity codes for a first group of tasks and a second group of tasks to make each task in the first group of tasks have a same affinity code with the task at a same position in the second group of tasks;
allocating the first group of cores to the first group of tasks at a first period of time after the first group of tasks are in the scheduling queue; and
allocating the first group of cores to the second group of tasks at a second period of time after the second group of tasks are in the scheduling queue;
wherein the first period of time and the second period of time do not overlap.

12. The method of claim 11, further comprising:
executing the first group of tasks after allocating a first group of cores to the first group of tasks, wherein the execution of the first group of tasks occupying the whole space of a tightly coupled memory (TCM); and
executing the second group of tasks after allocating the first group of cores to the second group of tasks, wherein the execution of the second group of tasks occupying the whole space of the TCM.

13. The method of claim 11, wherein when allocating a first group of cores to the first group of tasks and allocating the first group of cores to the second group of tasks, follow a bipartite matching algorithm, wherein the bipartite matching algorithm comprises the following steps:
for the first task in the scheduling queue, allocating a corresponding core of the first group of cores when a bit of the affinity code of the first task indicates the first task is allowed to be executed on the corresponding core;
for a second task beyond the first task, traverse the bits of the affinity code of the second task, whenever there is a bit of the affinity code of the second task indicates the second task is allowed to be executed on a corresponding core of the plurality of cores, executing the following steps:
checking whether the corresponding core has been allocated to a previous task according to one of the bits of the affinity code of the previous task or a core table of the corresponding core;
if the corresponding core has been allocated to a previous task, checking whether the previous task is allowed to be executed on another core of the plurality of cores according to another bit of the bits of the affinity code of the previous task;
reallocating the corresponding core to the second task, and allocating another core to the previous task when the previous task is allowed to be executed on another core, while remaining allocating the corresponding core to the previous task and moving to a next bit of the affinity code of the second task when the previous task isn't allowed to be executed on another core; and
if the corresponding core hasn't been allocated to a previous task, allocating the corresponding core to the second task.

14. A non-transitory machine-readable medium for storing a program code, wherein when loaded and executed by a processor comprising a plurality of cores, the program code instructs the processor to execute:
assigning an affinity code for each one of a plurality of tasks, wherein each affinity code comprises a plurality of bits, each bit of the plurality of bits indicates whether a task is allowed to be executed on a corresponding core of a plurality of cores; and
allocating at least one core of the plurality of cores to at least one task of the plurality of tasks according to a plurality of affinity codes assigned to the plurality of tasks after the plurality of tasks are in a scheduling queue.

15. The non-transitory machine-readable medium of claim 14, wherein when allocating at least one core of the plurality of cores to at least one task of the plurality of tasks according to the plurality of affinity codes assigned to the plurality of tasks, the processor executes:
allocating a corresponding core of the plurality of cores to a first task of the plurality of tasks when a bit of the affinity code of the first task indicates the first task is allowed to be executed on the corresponding core of the plurality of cores.

16. The non-transitory machine-readable medium of claim 15, wherein when allocating at least one core of the plurality of cores to at least one task of the plurality of tasks according to the plurality of affinity codes assigned to the plurality of tasks, the processor further executes:
for a second task beyond the first task, traverse the bits of the affinity code of the second task, whenever there is a bit of the affinity code of the second task indicates the second task is allowed to be executed on a corresponding core of the plurality of cores, executing the following steps:
checking whether the corresponding core has been allocated to a previous task according to one of the bits of the affinity code of the previous task or a core table of the corresponding core;
if the corresponding core has been allocated to a previous task, checking whether the previous task is allowed to be executed on another core of the plurality of cores according to another bit of the bits of the affinity code of the previous task;
reallocating the corresponding core to the second task, and allocating another core to the previous task when the previous task is allowed to be executed on another core, while remaining allocating the corresponding core to the previous task and moving to a next bit of the affinity code of the second task when the previous task isn't allowed to be executed on another core; and
if the corresponding core hasn't been allocated to a previous task, allocating the corresponding core to the second task.

17. The non-transitory machine-readable medium of claim 15, wherein the processor further executes:
creating or resetting a recording table to record the allocation status of the plurality of cores when starts traversing the bits of the affinity code of the second task.

18. A non-transitory machine-readable medium for storing a program code, wherein when loaded and executed by a processor comprising a first group of cores, the program code instructs the processor to execute:
assigning affinity codes for a first group of tasks and a second group of tasks to make each task in the first group of tasks have a same affinity code with the task at a same position in the second group of tasks;
allocating the first group of cores to the first group of tasks at a first period of time after the first group of tasks are in the scheduling queue; and
allocating the first group of cores to the second group of tasks at a second period of time after the second group of tasks are in the scheduling queue;
wherein the first period of time and the second period of time do not overlap.

19. The non-transitory machine-readable medium of claim 18, wherein the processor further executes:
executing the first group of tasks after allocating a first group of cores to the first group of tasks, wherein the execution of the first group of tasks occupying the whole space of a tightly coupled memory (TCM); and
executing the second group of tasks after allocating the first group of cores to the second group of tasks, wherein the execution of the second group of tasks occupying the whole space of the TCM.

20. The non-transitory machine-readable medium of claim 18, wherein when allocating a first group of cores to the first group of tasks and allocating the first group of cores to the second group of tasks, follow a bipartite matching algorithm, wherein the bipartite matching algorithm comprises the following steps:
for the first task in the scheduling queue, allocating a corresponding core of the first group of cores when a bit of the affinity code of the first task indicates the first task is allowed to be executed on the corresponding core;
for a second task beyond the first task, traverse the bits of the affinity code of the second task, whenever there is a bit of the affinity code of the second task indicates the second task is allowed to be executed on a corresponding core of the plurality of cores, executing the following steps:
checking whether the corresponding core has been allocated to a previous task according to one of the bits of the affinity code of the previous task or a core table of the corresponding core;
if the corresponding core has been allocated to a previous task, checking whether the previous task is allowed to be executed on another core of the plurality of cores according to another bit of the bits of the affinity code of the previous task;
reallocating the corresponding core to the second task, and allocating another core to the previous task when the previous task is allowed to be executed on another core, while remaining allocating the corresponding core to the previous task and moving to a next bit of the affinity code of the second task when the previous task isn't allowed to be executed on another core; and
if the corresponding core hasn't been allocated to a previous task, allocating the corresponding core to the second task.
